(19) United States
(12) Patent Application Publication
(10) Pub. No.: US 2002/0140720 A1
(43) Pub. Date: Oct. 3, 2002

(54) Device and method for displaying audio information

(75) Inventors: Koichi Uno, Iwaki-city (JP); Azusa Kanno, Iwaki-city (JP); Hideki Ito, Iwaki-city (JP)

Correspondence Address: Brinks Hofer Gilson & Lione, P.O. Box 10395, Chicago, IL, 60610, US

(73) Assignee: Alpine Electronics, Inc.

(21) Appl. No.: 10/109,984

(22) Filed: Mar. 28, 2002

(30) Foreign Application Priority Data
Mar. 29, 2001 (JP) 2001-097637

(51) Int. Cl. G09G 5/00

(52) U.S. Cl. 345/716

(57) ABSTRACT

An audio information display device for playing data recorded on a disc and for displaying information concerning the disc and tracks contained therein includes an artist information comparator/determinator. When the artist information comparator/determinator determines that a disc artist and a track artist are the same as each other, the track artist is not displayed. When it is determined that the disc artist differs from the track artist, and when it is determined that the current track artist is the same as the previous track artist, the track artist is not displayed. When scrolling information, only specific information is scrolled when a number-of-scrolls detector detects that the number of scrolls exceeds n times or when a user operates a scrolling-display switching key.

### BACKGROUND OF THE INVENTION

1. Field of the Invention

The present invention relates to audio information display devices and methods for displaying, on displays, title information and artist information for recording media being played and various types of playback information, such as information on songs being played when playing audio data recorded on recording media such as optical discs including compact discs (CDs), mini discs (MDs), and recordable CDs (CD-Rs) and in various types of memories. More particularly, the present invention relates to an audio information display device and a method for displaying information on a limited display area so that a user can easily recognize the displayed information.

2. Description of the Related Art

Due to advances in optical disc recording technology, CDs having songs recorded thereon, MDs on which users can arbitrarily record their favorite songs, and CD-Rs on which users can edit and record their favorite songs and which can be played back by CD players have become widely used. Further advances have been made in audio recording media, and digital versatile discs (DVDs), which are high-capacity recording media, have become widely used. Due to advances in data compression technology, a large number of songs can be compressed and recorded on CDs, DVDs, and memories using MP3 (MPEG-1 Audio Layer 3) technology, and the recorded data can be played back.

Advances have recently been made in in-vehicle apparatuses, including car audio apparatuses, and the demands of users have been increasing despite the fact that there is limited space in car interiors for installing these apparatuses. There has been an increasing need to install several different apparatuses, such as a car navigation apparatus, a CD player, an MD player, a head unit with a radio receiver, a DVD player, and a disc changer for storing a large number of various types of recording media such as CDs, MDs, and DVDs.

It is preferable that these apparatuses be located at a position which is as near as possible to the user, such as in a console box, so that the user can easily operate the apparatuses and recognize the operating states of these apparatuses. It is desirable to be able to efficiently install as many different apparatuses as possible in the limited console-box area. When developing in-vehicle apparatuses, it is very important to design the in-vehicle apparatuses so that they fit into the smallest possible area and so that users can easily operate these apparatuses.

For CDs, CD-text information concerning the discs can be recorded. For MDs, MD-title information can be recorded. For each disc, users can record title information, that is, the name of the disc, and artist information for the disc can also be recorded. For each song recorded on the disc, title information, that is, the title of the song, and artist information for the song can be recorded.

For in-vehicle CD players and MD players which are required to be arranged in a limited area as described above, it is preferable that title information and artist information for a disc being played, the title of a song being played, or, if necessary, the artist singing the song, be displayed for a user. For these players, a display for informing the user of such information is essential. In particular, it is preferable that the driver of a car be able to recognize the information at a glance.

In order to arrange these players in the limited area, such as 1 DIN (Deutsche Industrie Normen, i.e., German Industrial Standard, which is the standard for in-vehicle apparatuses) space, it is necessary to dispose the display in the remaining display area excluding portions in which various operation buttons, which are necessary for operating the players, are arranged. This remaining area is limited and relatively small. On this display, it is necessary to display various pieces of information concerning the disc or song being played in a manner recognizable to a driver. Characters displayed on the display cannot be too small. In many cases, each piece of information must be displayed on one line so that the information can be displayed in the limited information-display area.

In a playback-information display device for displaying information on a disc or song being played, information including title information and artist information for the disc being played, title information for each song, and, if necessary, artist information for each song can be displayed as clearly as possible in the following modes in accordance with the area of the portion capable of displaying information:

In a first mode, these pieces of information are displayed individually. In a second mode, the title and artist of a disc are grouped into disc text, or the title and artist of each song are grouped into track text, and then the disc text or the track text can be displayed. In a third mode, the title and artist of the disc are displayed together as disc text, and, for each song only the title is displayed.

Among the three display modes, the first mode has the following problem: At present, recording of the name of the artist performing each song is often omitted on commercially-available CDs since the artist of each disc is often the same as the artist performing each song on the disc. When displaying the information, artist information for each song is often blank, and thus a portion for displaying the artist information is useless. From a design point of view, the first mode is undesirable.

In the third mode, the name of the artist of each song is not displayed. When a disc contains songs performed by a single artist, there is no problem in the third mode. In contrast, when a disc is a compilation CD containing songs performed by various artists, that is, when songs recorded on a disc are performed by different artists, the fact that the name of the artist performing each song is not displayed is undesirable. Among the three display modes, the second mode, in which the title and artist of the disc are grouped into disc text to be displayed and the title and artist of each song are grouped into track text to be displayed, is preferred.

When displaying artist information for each song on a display, there are several types of CD-text containing various pieces of information about a CD. At present, many commercially-available CDs have the name of the artist of each disc recorded as artist information. In many cases, songs recorded on the disc are performed by a single artist, and hence the artist of the disc is the same as the artist of each song. Concerning CDs containing various songs such as compilation CDs, even when most of the songs are performed by a specific artist, the name of the artist is often recorded for each song. When a CD of a specific artist's album contains a duet, both artists of the duet may be recorded, and the artist of each of the other songs recorded on the CD may also be recorded.

In the case of an MD, a user selects songs to be recorded and inputs the selected songs. Taking into consideration the subsequent editing, the user often records the artist name(s) for all the songs as the MD-title. When the user selects songs from a CD and records the selected songs on a CD-R, similarly the user often records the artist name(s) for all the songs. When the user edits and records many more songs on a CD-R or in a memory using MP3 technology, the user often records the artist name(s) in the ID3 tags for all the songs for the sake of the subsequent editing since the user can simultaneously input the same name for all the songs when editing the songs using a personal computer (PC). In the ID3 tags, more information, such as the genre of each song, can be input.

Apart from recording music using MP3 compression technology, when the user edits many songs on a recording medium using various other recording technologies, the user often records various pieces of information including the title and the artist name of each of all the songs, the album title, and the genre.

As described above, even when a single artist has performed all the songs on a recording medium such as a CD, an MD, a CD-R, or a memory, the same artist name may be recorded for each of the songs. When not all, but many, of the songs are performed by a single artist, it is more likely that the artist's name will be recorded for all the songs corresponding to the artist name.

When the title and artist name of each song on a CD are recorded, as exemplified by the CD-text or MD-title in FIG. 4A, the display area on a player for playing audio recording media displays “Mariah Carey”, which is the same artist name as the artist name of the CD, when each song is displayed, as shown in FIG. 4B. When playing each of the songs on the disc, the same artist name as the artist name of the disc is displayed. Rather than being convenient, this may be annoying to the user.

When displaying various pieces of information on a relatively small display area of an in-vehicle audio apparatus, such as when displaying the title and artist name of each song, which are shown in FIG. 5B, it is common for the display area not to be able to display the title and the artist name at the same time. In such a case, the information is scrolled. When displaying more information including the genre of each song, the information cannot be displayed unless it is scrolled.

Referring to FIG. 6, portion (a) shows an example of the scrolling-display. In this example, the display area of the player only affords space for eight characters per line. Information to be displayed is automatically scrolled. Specifically, when the information includes the title of a song “Shape of My Heart”, the artist name “Backstreet Boys”, and the album title “Black & Blue”, the information is scrolled as shown in portion (a) in FIG. 6. The information continues to be scrolled until the song comes to an end.

In this case, the user is initially eager to know all the pieces of information concerning the song and looks at the displayed information. While listening to the song being played, the user may forget the information concerning the song. In such a case, it is common for the user to look at the display again. As described above, when the user again looks at the information the user has already seen once, it is very likely that the user wants to know the information specific to the song being played, and it is less likely that the user wants to see the information common to a series of songs being played. In many cases, the information specific to the song being played, that is, the information the user wants to know, is the title of the song.

When various pieces of information are repetitively scrolled in the manner described above, a user who wants to see the title of the song has to wait until the expected information is displayed because the information being displayed is long. If the user is a driver, the user, i.e., the driver, may be distracted or irritated since the expected information is not readily displayed.

Information displayed on a display of a player is useful only when the user wants to know information concerning a song being played. In other cases, however, the user may not want to know every piece of information. In such a case, displaying various pieces of information one after another is useless to the user. This may even ruin the aesthetic aspects of the entire display. In contrast, when specific information is displayed, the user will not be annoyed. The display may not change excessively, and the aesthetic aspects may be improved. [Not Applicable]

### SUMMARY OF THE INVENTION

Accordingly, it is an object of the present invention to provide an audio information display device and a method for displaying only information necessary for a user on a relatively small area of the display device and for scrolling necessary information of various pieces of information so that the user will not be annoyed and may clearly recognize the information being displayed.

In order to achieve the foregoing objects, according to an aspect of the present invention, an audio information display device is provided including an information data reading unit for reading individual title information representing a title of each of a plurality of audio tracks recorded on an audio recording medium being played, individual artist information representing an artist of each audio track, common title information representing a common title of the plurality of audio tracks, and common artist information representing a common artist of the plurality of audio tracks; and a display information selection/output unit for selecting information from the information data reading unit and providing the selected information to the display device. The display information selection/output unit does not display the individual artist information when the individual artist information is the same as the common artist information.

In accordance with another aspect of the present invention, an audio information display device is provided including an information data reading unit for reading individual title information representing a title of each of a plurality of audio tracks recorded on an audio recording medium being played, individual artist information representing an artist of each audio track, common title information representing a common title of the plurality of audio tracks, and common artist information representing a common artist of the plurality of audio tracks; and a display information selection/output unit for selecting information from the information data reading unit and providing the selected information to the display device. When the common artist information is not recorded on the audio recording medium being played, the display information selection/output unit does not display individual artist information which is the same as the individual artist information for the previously-played audio track.

In accordance with yet another aspect of the present invention, an audio information display device is provided including an information data reading unit for reading individual title information representing a title of each of a plurality of audio tracks recorded on an audio recording medium being played, individual artist information representing an artist of each audio track, common title information representing a common title of the plurality of audio tracks, and common artist information representing a common artist of the plurality of audio tracks; a display information selection/output unit for selecting information from the information data reading unit and providing the selected information to the display device; and a scroll controller for scrolling audio information on the display device. The display information selection/output unit only displays predetermined specific information when the number of scrolls is greater than or equal to a predetermined number.

In accordance with a further aspect of the present invention, an audio information display device is provided including an information data reading unit for reading individual title information representing a title of each of a plurality of audio tracks recorded on an audio recording medium being played, individual artist information representing an artist of each audio track, common title information representing a common title of the plurality of audio tracks, and common artist information representing a common artist of the plurality of audio tracks; a display information selection/output unit for selecting information from the information data reading unit and providing the selected information to the display device; and a scroll controller for sequentially and statically displaying audio information on the display device. The display information selection/output unit only displays predetermined specific information when the number of static-displays is greater than or equal to a predetermined number.

In accordance with another aspect of the present invention, an audio information display device is provided including an information data reading unit for reading individual title information representing a title of each of a plurality of audio tracks recorded on an audio recording medium being played, individual artist information representing an artist of each audio track, common title information representing a common title of the plurality of audio tracks, and common artist information representing a common artist of the plurality of audio tracks; a display information selection/output unit for selecting information from the information data reading unit and providing the selected information to the display device; and a scroll controller for scrolling audio information on the display device. The display information selection/output unit only displays predetermined specific information when a user enters a display switching operation.

In accordance with yet another aspect of the present invention, an audio information display device is provided including an information data reading unit for reading individual title information representing a title of each of a plurality of audio tracks recorded on an audio recording medium being played, individual artist information representing an artist of each audio track, common title information representing a common title of the plurality of audio tracks, and common artist information representing a common artist of the plurality of audio tracks; a display information selection/output unit for selecting information from the information data reading unit and providing the selected information to the display device; and a scroll controller for sequentially and statically displaying audio information on the display device. The display information selection/output unit only displays predetermined specific information when a user enters a display switching operation.

In accordance with a further aspect of the present invention, an audio information displaying method is provided including the acts of reading individual title information representing a title of each of a plurality of audio tracks recorded on an audio recording medium being played, individual artist information representing an artist of each audio track, common title information representing a common title of the plurality of audio tracks, and common artist information of a common artist of the plurality of audio tracks; selecting the read information and providing the selected information to a display device; and stopping the display of the individual artist information when the provided individual artist information is the same as the common artist information.

According to the present invention, when a recording medium has common artist information recorded thereon, in principle, each audio track recorded on the recording medium is performed by that artist. During playback of each song, unnecessary information such as the artist name is not displayed by a display device of the present invention. Thus, a user will not be annoyed since a long string of information is not displayed. Also, only information which is necessary for the user is displayed in a relatively small display area so that the user can easily recognize the displayed information. When a recording medium being played contains no common artist information, and when a series of audio tracks being played is performed by a single artist, that artist name is not repetitively displayed. Accordingly, the user will not be annoyed. When displaying playback information in the limited playback-information display area, the playback information is scrolled. Because a long string of information is not repetitively scrolled and information the user is interested in is promptly displayed, the user will not be annoyed, and thus the display device of the present invention is a user-friendly device. When the display device is located in a vehicle, the driver of the vehicle can promptly recognize the information the driver is interested in since the information is promptly displayed. As a result, the driver will not be distracted from safe driving. When a long string of information is scrolled, preset information the user is most interested in is promptly displayed in response to a user's display switching operation. Hence, the user will not be annoyed. Because there is limited space in a car interior for installing various apparatuses, the space allowed for a display device is small. In such a case, the display device of the present invention for displaying only necessary information is able to be effectively utilized.

### BRIEF DESCRIPTION OF THE DRAWINGS

FIG. 1 is a functional block diagram of an audio information display device according to an embodiment of the present invention;

FIG. 2 is a flowchart showing a process of displaying a track artist in this embodiment;

FIG. 3 is a flowchart showing a process of performing scrolling-display in this embodiment;

FIGS. 4A to 4C show display examples in which a track artist is not displayed when the track artist is the same as a disc artist according to the present invention, wherein FIG. 4A shows an example of data, namely, CD-text or MD-title, recorded on a disc; FIG. 4B shows a display example of the CD-text or the MD-title by a known display device; and FIG. 4C shows a display example of the CD-text or the MD-title according to the present invention in which the track artist which is the same as the disc artist is not displayed;

FIGS. 5A and 5B show display examples of track artists when no disc artist information is recorded, wherein FIG. 5A shows an example of data, namely, CD-text or MD-title, recorded on a disc, and FIG. 5B shows a display example of the CD-text or the MD-title according to the present invention in which the track artist which is the same as the previous track artist is not displayed;

FIG. 6 shows examples of scrolling-display when the entire information is continuously scrolled n times, wherein portion (a) shows an example of a known scrolling-display, and portion (b) shows an example of a scrolling-display according to the present invention; and

FIG. 7 shows examples of scrolling-display in response to a scrolling-display switching key operated by a user, wherein portion (a) shows an example of a known scrolling-display, and portion (b) shows an example of a scrolling-display according to the present invention.

### DESCRIPTION OF THE PREFERRED EMBODIMENTS

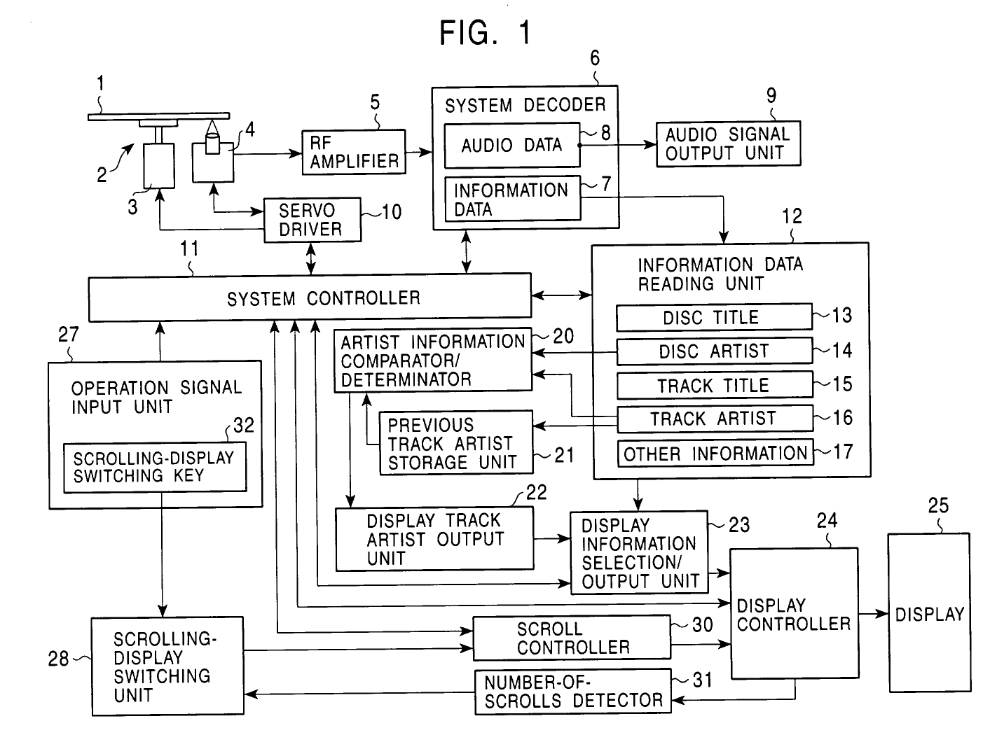

The present invention will now become clear from the following description of the preferred embodiments with reference to the accompanying drawings. FIG. 1 is a functional block diagram of an audio information display device according to an embodiment of the present invention. In this example, the audio information display device is applied to a player for playing a disc 1, such as a CD or an MD, having audio tracks recorded thereon. Referring to FIG. 1, the disc 1 is placed in a player 2 and is rotated by a motor 3. An optical pickup 4 reads recorded RF data while moving with respect to the axis of the disc 1 in the radial direction. The motor 3 and the optical pickup 4 are under the control of a servo driver 10 which receives signals from a system controller 11 for controlling the entire audio disc player 2, thus starting and stopping playback and reading various data from an arbitrary portion of the disc 1.

Signals from the optical pickup 4 are amplified by an RF amplifier 5 and the amplified signals are input to a system decoder 6 which can separately decode, of the data recorded on the disc 1, information data 7 for songs contained in the disc 1 and audio data 8. The operation of the system decoder 6 is controlled by the system controller 11. As in a known player, the decoded audio data 8 is output from an audio signal output unit 9 and is subjected to various signal processing. The processed signals are output from a speaker (not shown).

The information data 7 includes information about playback processing of audio tracks, information for the disc 1 being played, and track information for songs contained in the disc 1. The information data 7 is read by an information data reading unit 12. In this example shown in FIG. 1, the information data reading unit 12 reads a disc title 13 of the disc 1 being played, a disc artist 14, a track title 15, a track artist 16, and, if necessary, other information 17 including the recording date of the disc 1, the genre, etc.

The data is appropriately selected by a display information selection/output unit 23 as described below. The selected data is provided to a display controller 24 and is consequently displayed on a display 25. The display information selection/output unit 23 operates in accordance with operation flows determined in advance by the system controller 11 (described below) and performs a process of displaying a track artist and a process of selecting information and scrolling the selected information.

An artist information comparator/determinator 20 receives the disc artist 14 and the track artist 16, which are read by the information data reading unit 12, and performs a first determination step of determining whether the track artist 16 is the same as the disc artist 14 by comparison. The determination result is output to a display track artist output unit 22.

In response to the determination result from the artist information comparator/determinator 20 that the track artist 16 is the same as the disc artist 14, the display track artist output unit 22 provides a signal to the display information selection/output unit 23 so that the track artist may not be displayed in order not to annoy the user by repetitively displaying the same artist name.

A previous track artist storage unit 21 updates and stores an artist performing a song previous to the song being currently played, that is, a previous track artist. The artist information comparator/determinator 20 receives the previous track artist data and, when the disc 1 contains no data for the disc artist 14, performs a second determination step of determining whether the previous track artist is the same as the current track artist. The determination result is provided to the display track artist output unit 22.

In response to the determination result from the artist information comparator/determinator 20 that the previous track artist is the same as the current track artist, the display track artist output unit 22 provides a signal to the display information selection/output unit 23 so that the track artist may not be displayed in order not to annoy the user by repetitively displaying the same artist name as the previous one.

The display information selection/output unit 23 receives various pieces of information from the information data reading unit 12. In accordance with an instruction from the system controller 11, the display information selection/output unit 23 selects and combines a disc title and a disc artist or a track title and, if necessary, a track artist and displays the combined information. Also, the display information selection/output unit 23 selects pieces of information to be scrolled and scrolls the selected pieces of information in sequence. Whether the track artist is to be displayed is determined on the basis of a signal from the display track artist output unit 22 indicating whether or not the track artist is to be displayed.

The display information selection/output unit 23 selects the information and outputs the information to the display controller 24. In accordance with an instruction from the system controller 11, the display controller 24 controls the display 25 so that the information is displayed in a predetermined order. When all of the information cannot be displayed because the display area of the display 25 is too small, the information is sequentially displayed using an appropriate scrolling method. The scrolling-display is also controlled by a signal from a scroll controller 30 described below.

A number-of-scrolls detector 31 detects the number of scrolls, that is, the number of times the information is repetitively scrolled by the display controller 24. The number-of-scrolls detector 31 provides the number-of-scrolls data to a scrolling-display switching unit 28. The scrolling-display switching unit 28 detects whether or not the number-of-scrolls data is greater than or equal to a predetermined number n, such as three. When the number of scrolls is greater than or equal to the predetermined number, the scrolling-display switching unit 28 provides a first scrolling switching signal to the scroll controller 30 indicating that only predetermined information such as a track title be displayed in order not to annoy the user by repetitively displaying a long string of information.

An operation signal input unit 27 is connected to the system controller 11 for performing player functions in response to user operations. Operation signals include operation signals entered using keys, remote control keys, and a touch panel provided on the player. Also, operation signals can be entered using voice recognition. The operation signal input unit 27 contains a scrolling-display switching key 32 for enabling the user to arbitrarily set a scrolling-display as described above. The scrolling-display switching key 32 can be a scrolling-display switching key provided on the player, a scrolling-display switching key provided on the remote control, a touch panel, or a signal by voice recognition.

The scrolling-display switching unit 28 receives a signal from the scrolling-display switching key 32. In response to a signal entered by operating the scrolling-display switching key 32, the scrolling-display switching unit 28 provides a second scrolling switching signal to the scroll controller 30 so that only predetermined information, such as a disc title (album title), may be scrolled.

The scroll controller 30 receives a control signal from the system controller 11 and the first and second scrolling switching signals from the scrolling-display switching unit 28. In response to the first scrolling switching signal after the long string of information has been displayed n times or more, the scroll controller 30 provides a signal to the display controller 24 to only display predetermined information such as the title of a song. The display 25 is switched from displaying the long string of information to simply scrolling the track title.

In response to the second scrolling switching signal which is provided in response to a user's key operation, the scroll controller 30 instructs the display controller 24 to switch from scrolling a long string of information to simply scrolling a predetermined piece of information, such as the disc title. The selection of pieces of information to be scrolled is performed by the display information selection/output unit 23 under the control of the system controller 11. The display controller 24 displays the selected information on the display 25 by scrolling the information in accordance with a signal from the scroll controller 30.

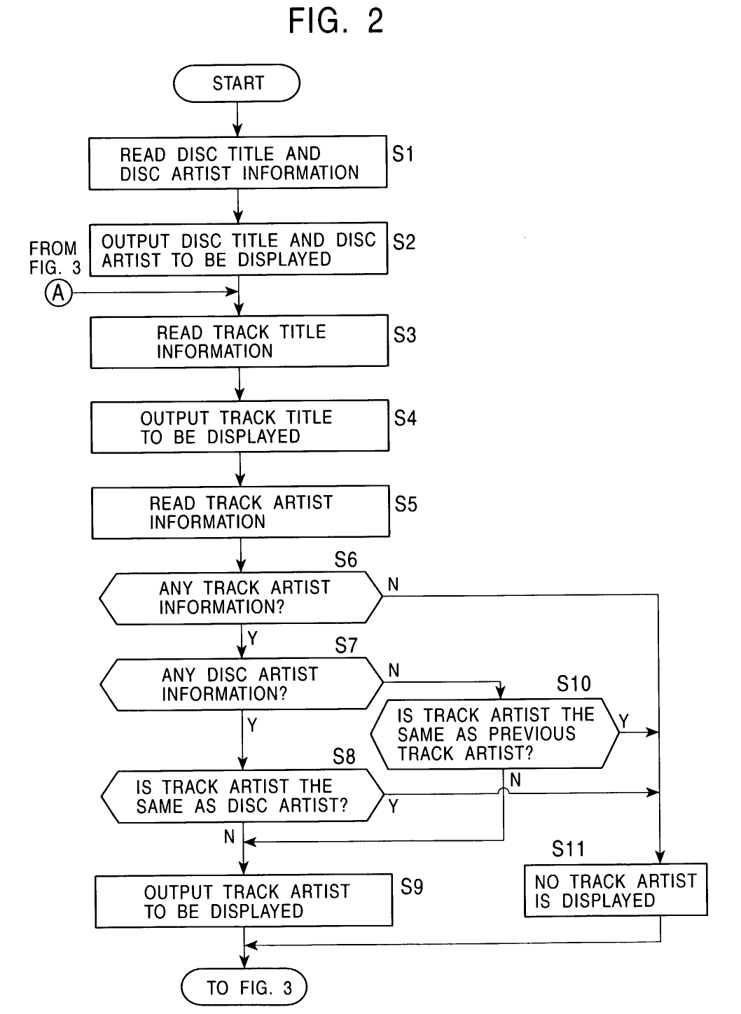

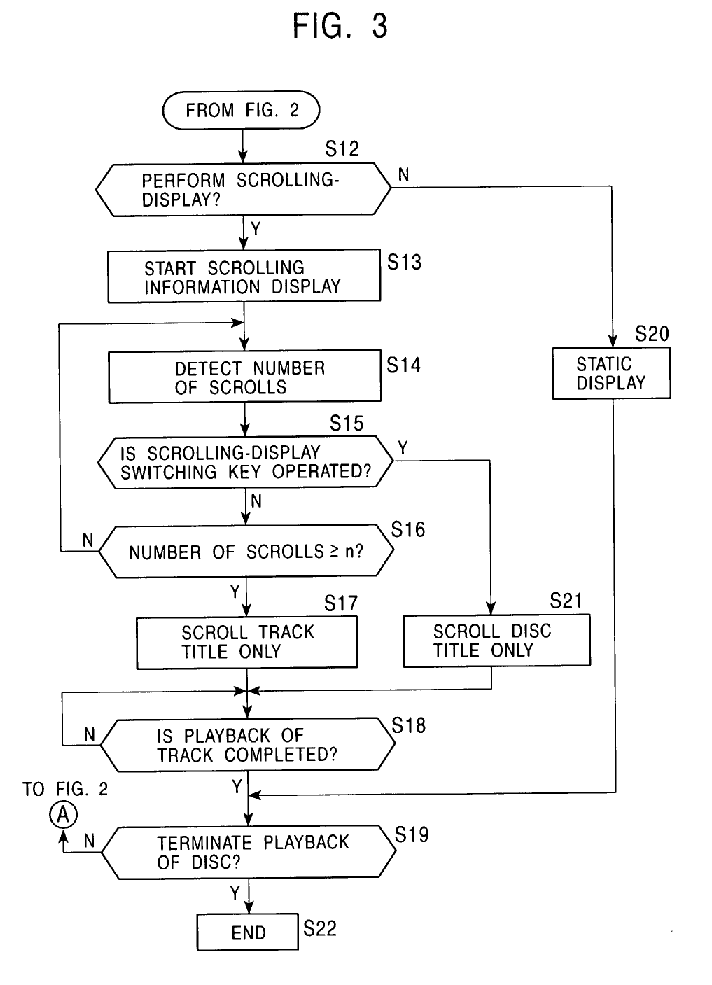

According to the present invention, the audio information display device including the above-described functional blocks can be operated by an operation flow shown in FIG. 2 and an operation flow shown in FIG. 3, which is performed subsequent to or independently of the operation flow shown in FIG. 2. These operation flows will now be described with reference to FIGS. 1, 4A to 4C, 5A and 5B, 6, and 7. FIG. 2 shows a process of displaying disc playback information. When a disc is placed in a player and the player starts playing the disc, this process starts. The process reads the disc title and disc artist information (step S1) and provides the read information to be displayed (step S2).

The information to be displayed can be provided by storing the information in a corresponding buffer portion of a display memory for storing information. Various pieces of information described below are similarly provided for display. As in some compilation CDs, the disc may contain no disc artist information. In such a case, no information is detected even when the disc is read, and there is substantially no output data.

The process reads the title of a song to be played, that is, track title information (step S3), and provides the track title to be displayed (step S4). Reading and outputting/displaying the information is performed by the information data reading unit 12 reading the information data 7 separated by the system decoder 6. Subsequently, the display information selection/output unit 23 selects the read disc title 13, the disc artist 14, and the track title 15 and supplies the selected information to a memory provided in the display controller 24.

Subsequently, the process reads track artist information for the song to be played (step S5) and determines whether or not the track artist information exists on the basis of the reading result (step S6). When it is determined that there is no track artist information, the process proceeds to step S11 and displays no track artist. In this example, the process proceeds to the subsequent scrolling-display process.

When it is determined in step S6 that the track artist information exists, the process determines whether or not the disc artist information read in step S1 actually exists (step S7). If the determination is affirmative, it is determined whether or not the track artist is the same as the disc artist (step S8). If it is determined that the track artist is not the same as the disc artist, the track artist is output and displayed (step S9).

If it is determined in step S7 that there is no disc artist information, the process proceeds to step S10 and determines whether or not the artist of a track to be played is the same as the previous track artist. If the determination is negative, that is, if the track artist differs from the previous track artist, the process proceeds to step S9 and outputs the track artist to be displayed.

In contrast, if it is determined in step S8 that the track artist is the same as the disc artist, no track artist is displayed (step S11). Specifically, the user already knows the disc artist information since the user has seen the disc artist which has been displayed. When no track artist is displayed, the user can assume that the current track artist is the same as the previously-displayed disc artist and recognize that the song being currently played is performed by the disc artist. Thus, the user will not be annoyed since the same artist is not repetitively displayed.

When it is determined in step S7 that there is no disc artist information, and when it is determined in step S10 that the current track artist is the same as the previous track artist, the track artist is not displayed (step S11). Specifically, without the determination in step S10, all the track artists would be displayed when no disc artist is recorded. In contrast, with the determination in step S10, even when no disc artist information is recorded, a current track artist which is the same as the previous track artist is not displayed. Accordingly, the user will not be annoyed since the same artist is not repetitively displayed.

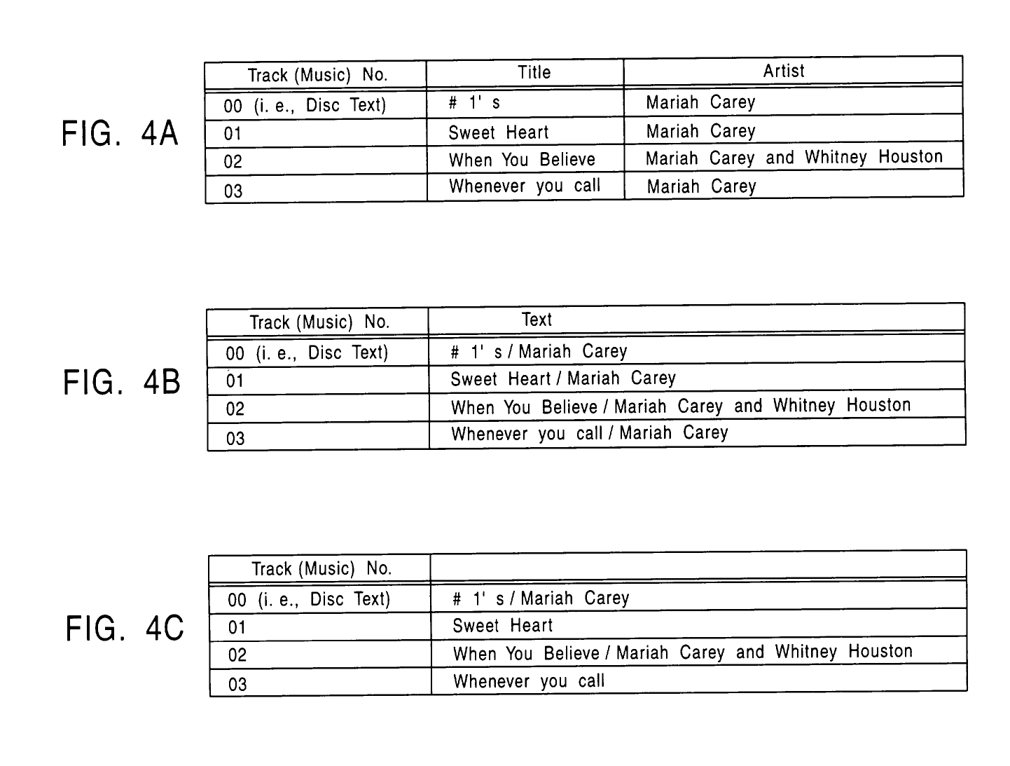

FIGS. 4A to 4C show information displayed as a result of the foregoing track-artist displaying process. Specifically, FIG. 4A shows CD-text recorded on a CD or an MD-title recorded on an MD when a disc to be played is a CD or MD, respectively. FIG. 4B shows the information displayed by a known playback information display device. FIG. 4C shows the information displayed according to the present invention as a result of the processing in step S8.

Specifically, in this example, track number 00 of the disc is disc text, which in this case is “#1's”, and the disc artist is Mariah Carey. A song recorded on the disc which is indicated as track number 01 has the track title “Sweet Heart”, and the track artist is the same as the disc artist Mariah Carey.

Similarly, track number 02 has the track title “When You Believe”, and the track artists are a duet by Mariah Carey and Whitney Houston. Track number 03 has the track title “Whenever you call” and the track artist is Mariah Carey.

When playing the disc, a known playback information display device displays, as shown in FIG. 4B, the disc information “#1's/Mariah Carey”. After this, the track information and the track artist of the first song, namely, “Sweet Heart/Mariah Carey” is displayed as a single string of information. Similarly, for each track, a pair consisting of the track title and the track artist is displayed. Specifically, for track number 02, “When You Believe/Mariah Carey and Whitney Houston” is displayed; for track number 03, “Whenever you call/Mariah Carey” is displayed. Although the information displayed for track number 02, which is a duet, is appropriate, the information displayed for the other tracks is repetitive since the track artist of each of these songs is the same as the disc artist.

Displaying the track artist as described above is performed in the following manner. Generally, known CDs do not have information recorded on a portion for recording track artist information since all the songs on a disc are performed by the same artist except in special circumstances as in compilation CDs. When playing such a known CD, without special processing, no track artist is displayed when the disc artist is the same as the track artist. Thus, the user is not annoyed since the same track artist is not repetitively displayed. Only when a disc contains a duet as described above does the disc have track artist information for the other songs recorded thereon.

As described above, since the user often edits and records various songs on an MD, track artist information is often written for each song on the MD. Particularly, when the user edits songs on a CD-R using a PC, track artist information is often written for all the songs on the CD-R taking into consideration the future transfer of data and the ease of data copying using a PC. For these reasons, recently in particular, the user is often annoyed at playback information displayed on a disc player.

According to the present invention, as shown in FIG. 4C, the disc information “#1's/Mariah Carey” is displayed, which is the same as that displayed by the known display device. For track number 01, the track artist is the same as the disc artist. Thus, display of the track artist is omitted, and only the track title “Sweet Heart” is displayed for track number 01.

For track number 02, part of the track artists differs from the disc artist. Thus, the track title and the track artists are displayed, i.e., the information “When You Believe/Mariah Carey and Whitney Houston” is displayed. Alternatively, when only part of the track artist(s) differs from the disc artist, it can be determined that the track artist(s) and the disc artist are the same as each other, and hence no track artist(s) is displayed. For track number 03, the track artist is the same as the disc artist. Thus, display of the track artist is omitted, and only the track title “Whenever you call” is displayed.

Accordingly, when a disc being played contains disc artist information, no track artist is displayed when the track artist is the same as the disc artist. Even when a disc such as an MD or a CD-R on which track artist information is often recorded for each track is being played, the same track artist is not repeatedly displayed, and hence the user will not be annoyed.

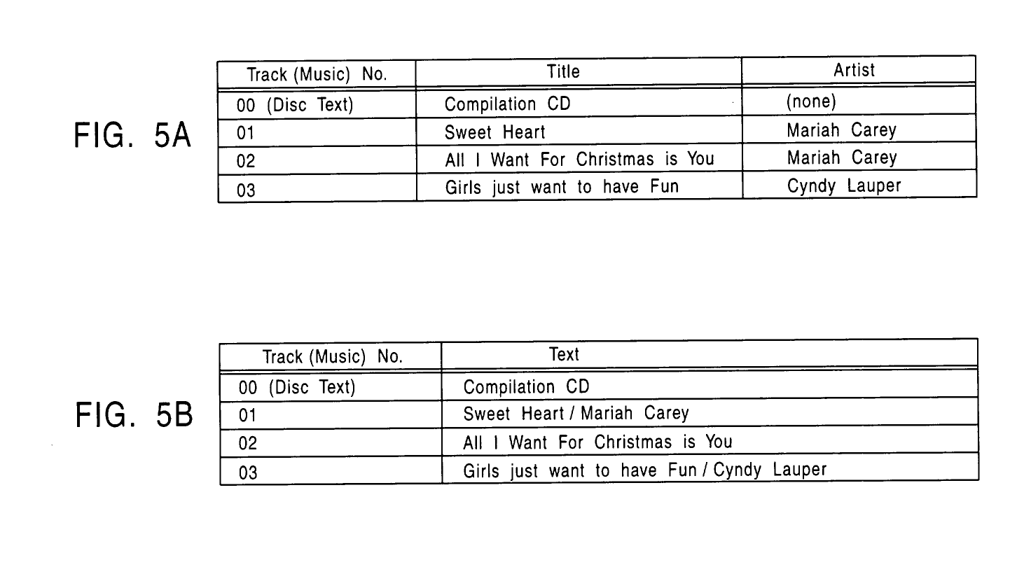

Referring to FIG. 5A, when no disc artist is recorded on a disc to be played, display of the track artist is omitted when the track artist is the same as the previous track artist, as shown in FIG. 5B. Specifically, FIG. 5A shows an example of a compilation CD. The disc title “Compilation CD” is recorded, and no disc artist is recorded. Songs contained in the disc include track numbers 01 and 02 by Mariah Carey and track number 03 by Cyndy Lauper.

When playing such a disc, as shown in FIG. 5B, the disc information, that is, only the disc title “Compilation CD”, is displayed. For track number 01, the track title and the track artist, namely, “Sweet Heart/Mariah Carey”, are displayed. For track number 02, the track artist is the same as the previous track artist, Mariah Carey. Thus, display of the track artist is omitted, and only the track title “All I want For Christmas is You” is displayed. For track number 03, the track artist Cyndy Lauper differs from the previous track artist Mariah Carey, and hence the track artist should be displayed. As a result, “Girls just want to have Fun/Cyndy Lauper” is displayed.

Even when playing a compilation CD on which no disc artist is recorded or an MD or a CD-R on which no disc artist name is recorded since various songs are combined, display of the track artist is omitted when the track artist is the same as the previous track artist. Thus, the user will not be annoyed.

Referring again to FIG. 2, when the track artist is provided and displayed in step S9 or when no track artist is displayed in step S11, the process proceeds to a process of scrolling playback information shown in FIG. 3. Specifically, the scrolling-display process determines whether or not to perform scrolling-display (step S12). When it is determined that the display has enough space for simultaneously displaying all of the information, or when the display 25 has enough space for sequentially displaying each piece of information although individual pieces of information are displayed separately, or when text data to be displayed is so short that the entire data can be displayed without scrolling, the process proceeds to step S20 and performs static display in which no scrolling is performed. If desired, the process can perform scrolling-display in any one of the above-described cases in order to improve the aesthetic aspects of the display 25.

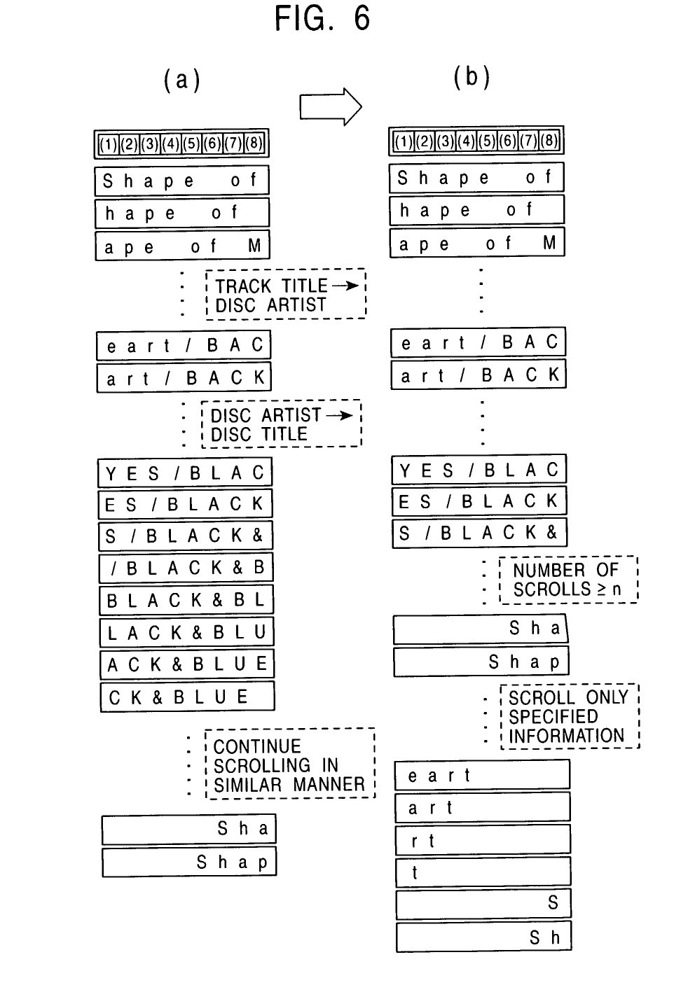

When it is determined in step S12 to perform scrolling-display, the process starts scrolling various pieces of information on the display 25 (step S13). For example, the disc title of a disc to be played is “Black & Blue”; the disc artist is “Backstreet Boys”; the current track title is “Shape of My Heart”; all the songs on the disc are performed by the disc artist, namely, the “Backstreet Boys”; and no track artist information is recorded for each individual song. In this case, as described with reference to FIG. 2, it is determined in step S6 that there is no track artist information, and, as a result, no track artist is displayed in step S11. In this state, the process proceeds to step S13 in FIG. 3. Thus, the process scrolls information except for the track artist. The process starts scrolling information in the state shown in portion (a) in FIG. 6, which is illustrated as a known example of a scrolling-display.

In the example shown in portion (a) in FIG. 6, the display 25 has eight character display regions (1) to (8). When displaying disc and track information, the track title, the disc artist, and the disc title are displayed in these character display regions (1) to (8) and are scrolled in this order. When playing a disc having recorded thereon the foregoing information, the information “Shape of My Heart/Backstreet Boys/Black & Blue” is scrolled. In the known example shown in portion (a) in FIG. 6, all the pieces of information are similarly and repetitively scrolled in this order.

After the process starts scrolling the information, the process detects the number of scrolls (step S14). The number of scrolls can be detected by the number-of-scrolls detector 31 shown in FIG. 1. The detected number of scrolls is used in step S16 as described below. It is determined whether or not the scrolling-display switching key 32 is operated by the user (step S15). When the user has not operated the scrolling-display switching key 32 in the operation signal input unit 27 shown in FIG. 1, the process proceeds to step S16 and determines whether the number of scrolls is greater than or equal to a predetermined number n. The predetermined number n can be set to an arbitrary number, such as four.

When it is determined that the number of scrolls has not reached n, for example, when the predetermined number n is set to four and when the number of scrolls is less than four, that is, when three scrolls have been completed, the process returns to step S14 and again detects the number of scrolls. From this step onward, the process similarly and repetitively determines whether or not the scrolling-display switching key 32 has been operated.

When it is determined in step S16 that the number of scrolls is greater than or equal to n, that is, in this example, when the number of scrolls determined in step S14 is four, only the track title is scrolled in this example. Accordingly, all of the information is repetitively scrolled three times, and when it is determined in step S14 that the fourth scroll is to be performed, the process starts scrolling only the track title. The selection of the information to be scrolled is performed by the display information selection/output unit 23 shown in FIG. 1 in accordance with an instruction from the system controller 11.

In practice, the scrolling-display is performed as shown in portion (b) in FIG. 6. Specifically, for the first n times, the track title, the disc artist, and the disc title are scrolled in this order, that is, the information “Shape of My Heart/Backstreet Boys/Black & Blue” is scrolled, as in the known example shown in portion (a) in FIG. 6. In this example, after the information is scrolled three times, only the track title “Shape of My Heart” is scrolled.

When a long string of information is continuously scrolled, it is difficult for the user who generally wants to know the title of a song being currently played, that is, the track title, to quickly find the desired information from the long string of information. The user must look at the information being scrolled for a while in order to find the track title. When a driver of a car looks at the information displayed in such a manner, the driver's mind is often distracted from safe driving. In contrast, with the foregoing arrangement according to the present invention, after all of the information has been displayed a predetermined number of times, only the track artist is displayed. Thus, playback information can be displayed in a manner in which the user can easily recognize the displayed information.

Although only the track title is scrolled from the n-th scroll onward in this embodiment, it is possible to preset the display device to scroll only the artist name of the disc being currently played, that is, only the disc artist, or to scroll only the disc title.

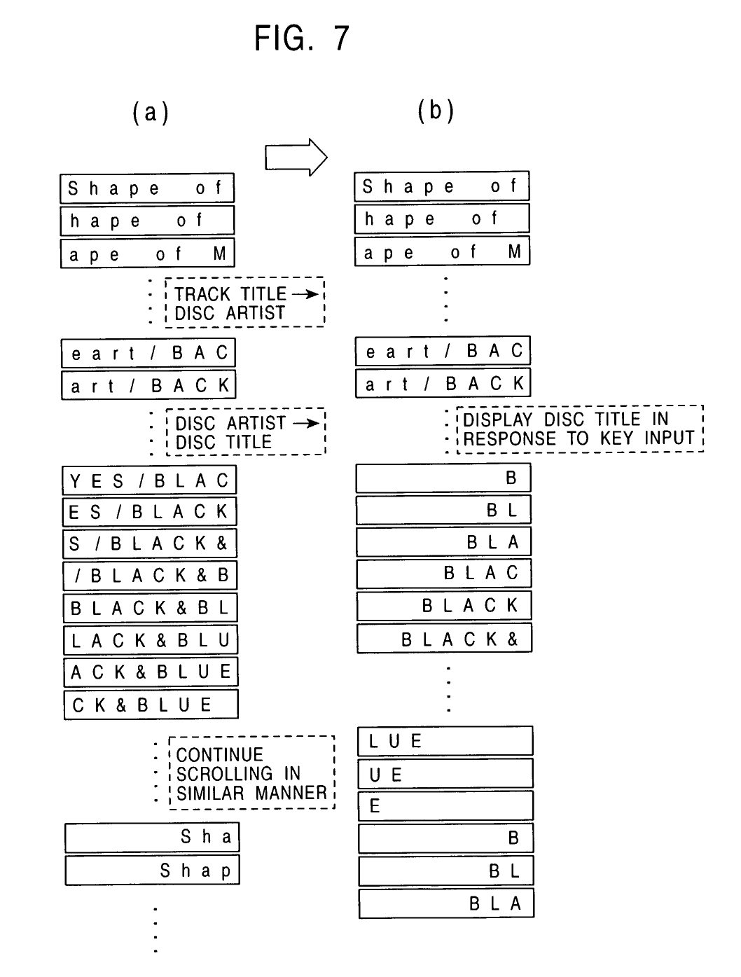

When it is determined that the scrolling-display switching key 32 is operated in step S15, that is, when the user gives an instruction to switch the scrolling-display by operating the key of the operation signal input unit 27 shown in FIG. 1, only the disc title is scrolled in this embodiment. For example, as shown in portion (b) in FIG. 7, the display 25 is switched from scrolling all of the information as previously performed, as shown in portion (a) in FIG. 7, to scrolling only the disc title. In other words, when the entire information is scrolled n times, only the disc title is scrolled in response to a display switching key input. As described above, it is possible to set arbitrary information to be displayed. For example, only the disc artist name can be scrolled, or only the track artist name can be scrolled. The selection of information to be displayed is performed by the display information selection/output unit 23 under the control of the system controller 11.

When scrolling only specific information in response to a display switching key operation, the specific information can be scrolled after the entire information has been scrolled n times. Alternatively, depending on the information selection setting, the following operation is possible. For example, the number of times the entire information is to be scrolled can be set to a large number, such as seven. When the user performs a key operation before the entire information has been scrolled seven times, the specific information is immediately displayed. In this way, the information can be displayed in accordance with the user's intention. The specific information to be displayed in response to a user's key operation can be set by providing a menu from which the user can arbitrarily select information and by presetting, by the user, the specific information to be displayed using the menu.

In this embodiment, an example in which a disc being played has no track artist information recorded thereon, such as in a normal CD, has been described. When playing a CD-R having audio data from various audio recording media recorded thereon using various compression technologies including MP3 technology, that is, when playing a CD-R on which no disc artist name is recorded and only the name of the artist of each song, i.e., the track artist, is recorded, it is possible to select that track artist be displayed.

As described above, subsequent to step S17 in which only the preset information, such as the track title, is scrolled after the entire information has been scrolled n times or subsequent to step S21 in which only the preset information, such as the disc title, is scrolled in response to a user's display switching key input, it is determined whether or not the playback of the track is completed (step S18). When it is determined that the playback is not completed, the process waits in the display state until the playback of the track is completed.

When it is determined that the playback of the track is completed, or when the display device is not in the scrolling-display mode but in the static display mode in step S20, it is determined whether to terminate the playback of the disc (step S19). When it is determined to terminate the playback of the disc, that is, when the playback of the disc according to a predetermined playback program will come to an end since the track being currently played is the last track, or when the user gives a disc playback stopping instruction, the operation flow is terminated (step S22).

When it is determined not to terminate the playback of the disc, that is, when the process is not in the halt playback state, the process returns to step S3 in FIG. 2 and reads new track title information. The operation from step S3 onward is repeated until it is determined to stop the playback of the disc.

The present invention is not limited to the foregoing embodiment and can be implemented in various ways. For example, although the operation flows shown in FIGS. 2 and 3 are continuously performed in the foregoing embodiment, the operation flows can be separately performed. In each operation, the playback information can be clearly displayed, which is the object of the present invention.

With reference to FIG. 2, two cases in which the track artist is not displayed have been described. In one case, the disc artist and the track artist are the same as each other. In the other case, no disc artist information is recorded, and the track artist being played is the same as the previous track artist. However, the present invention can be implemented by performing processing in only one of the two cases. In the foregoing embodiment, processing in the two cases has been described as a preferred embodiment of the present invention.

Similarly, one case in which predetermined information is displayed when the entire information is scrolled n times or more, and another case in which predetermined information is displayed in response to a user's display switching key operation, have been illustrated in the foregoing embodiment. However, the present invention can be implemented by performing processing in only one of the two cases. In the foregoing embodiment, processing in the two cases has been described as a preferred embodiment of the present invention.

Although cases in which audio data is recorded on discs such as a CD, an MD, and a CD-R have been described in the foregoing embodiment, the present invention is applicable to cases in which information on audio recording media, such as a DVD, a hard disc, various memory cards, and memory chips, is displayed when playing audio data recorded on these audio recording media.

What is claimed is:

1. An audio information display device comprising:
an information data reading unit for reading at least one of individual title information representing a title of each of a plurality of audio tracks recorded on an audio recording medium being played, individual artist information representing an artist of each audio track, common title information representing a common title of the plurality of audio tracks, and common artist information representing a common artist of the plurality of audio tracks; and
a display information selection/output unit for selecting information from the information data reading unit and providing the selected information to a display device,
wherein the display information selection/output unit does not display the individual artist information when the individual artist information is the same as the common artist information.

2. An audio information display device according to claim 1, wherein the plurality of audio tracks recorded on the audio recording medium comprise audio tracks recorded on a CD-R using MP3 technology.

3. An audio information display device comprising:
an information data reading unit for reading at least one of individual title information representing a title of each of a plurality of audio tracks recorded on an audio recording medium being played, individual artist information representing an artist of each audio track, common title information representing a common title of the plurality of audio tracks, and common artist information representing a common artist of the plurality of audio tracks; and
a display information selection/output unit for selecting information from the information data reading unit and providing the selected information to a display device,
wherein, when the common artist information is not recorded on the audio recording medium being played, the display information selection/output unit does not display individual artist information which is the same as the individual artist information for the previously-played audio track.

4. An audio information display device according to claim 3, wherein the audio recording medium comprises a hard disk.

5. An audio information display device according to claim 3, wherein the display information selection/output unit does not display the individual artist information when the individual artist information is the same as the common artist information.

6. An audio information display device comprising:
an information data reading unit for reading at least one of individual title information representing a title of each of a plurality of audio tracks recorded on an audio recording medium being played, individual artist information representing an artist of each audio track, common title information representing a common title of the plurality of audio tracks, and common artist information representing a common artist of the plurality of audio tracks;
a display information selection/output unit for selecting information from the information data reading unit and providing the selected information to a display device; and
a scroll controller for scrolling audio information on the display device,
wherein the display information selection/output unit only displays predetermined specific information when a number of scrolls is greater than or equal to a predetermined number.

7. An audio information display device according to claim 6, wherein the plurality of audio tracks recorded on the audio recording medium comprise audio tracks recorded on a CD-R using MP3 technology.

8. An audio information display device according to claim 6, wherein the display information selection/output unit can set the number of scrolls to an arbitrary number.

9. An audio information display device comprising:
an information data reading unit for reading at least one of individual title information representing a title of each of a plurality of audio tracks recorded on an audio recording medium being played, individual artist information representing an artist of each audio track, common title information representing a common title of the plurality of audio tracks, and common artist information representing a common artist of the plurality of audio tracks;
a display information selection/output unit for selecting information from the information data reading unit and providing the selected information to a display device; and
a scroll controller for sequentially and statically displaying audio information on the display device,
wherein the display information selection/output unit only displays predetermined specific information when a number of static-displays is greater than or equal to a predetermined number.

10. An audio information display device according to claim 9, wherein the audio recording medium comprises a memory chip.

11. An audio information display device according to claim 9, wherein the display information selection/output unit can set the number of static-displays to an arbitrary number.

12. An audio information display device comprising:
an information data reading unit for reading at least one of individual title information representing a title of each of a plurality of audio tracks recorded on an audio recording medium being played, individual artist information representing an artist of each audio track, common title information representing a common title of the plurality of audio tracks, and common artist information representing a common artist of the plurality of audio tracks;
a display information selection/output unit for selecting information from the information data reading unit and providing the selected information to a display device; and
a scroll controller for scrolling audio information on the display device,
wherein the display information selection/output unit only displays predetermined specific information when a user enters a display switching operation.

13. An audio information display device according to claim 12, wherein the plurality of audio tracks recorded on the audio recording medium comprise audio tracks recorded on a CD-R using MP3 technology.

14. An audio information display device according to claim 12, wherein the display information selection/output unit only displays the predetermined specific information when a number of scrolls is greater than or equal to a predetermined number.

15. An audio information display device according to claim 12, wherein the display switching operation entered by the user is entered by voice recognition.

16. An audio information display device comprising:
an information data reading unit for reading at least one of individual title information representing a title of each of a plurality of audio tracks recorded on an audio recording medium being played, individual artist information representing an artist of each audio track, common title information representing a common title of the plurality of audio tracks, and common artist information representing a common artist of the plurality of audio tracks;
a display information selection/output unit for selecting information from the information data reading unit and providing the selected information to a display device; and
a scroll controller for sequentially and statically displaying audio information on the display device,
wherein the display information selection/output unit only displays predetermined specific information when a user enters a display switching operation.

17. An audio information display device according to claim 16, wherein the audio recording medium comprises a hard disk.

18. An audio information display device according to claim 16, wherein the display information selection/output unit only displays the predetermined specific information when a number of static-displays is greater than or equal to a predetermined number.

19. An audio information display device according to claim 16, wherein the display switching operation entered by the user is entered by voice recognition.

20. An audio information displaying method comprising:
reading at least one of individual title information representing a title of each of a plurality of audio tracks recorded on an audio recording medium being played, individual artist information representing an artist of each audio track, common title information representing a common title of the plurality of audio tracks, and common artist information of a common artist of the plurality of audio tracks;
selecting from the read information and providing the selected information to a display device; and
stopping the display of the individual artist information when the individual artist information is the same as the common artist information.
